(19) United States
(12) Patent Application Publication
(10) Pub. No.: US 2019/0240608 A1
(43) Pub. Date: Aug. 8, 2019

(54) Determination of Dust Load in a Bag Filter

(71) Applicant: FLSmidth A/S, Valby (DK)

(72) Inventor: Sunil Rajaram, Chennai (IN)

(21) Appl. No.: 16/343,149

(22) PCT Filed: Oct. 11, 2017
(86) PCT No.: PCT/IB2017/056287

§ 371 Date: Apr. 18, 2019

(30) Foreign Application Priority Data
Oct. 20, 2016 (DK) PA 2016 70826

(51) Int. Cl. B01D 46/00

(52) U.S. Cl. CPC B01D 46/0086; B01D 46/06

(57) ABSTRACT

A bag filter system for removing dust from a gas flow comprises a plurality of filter bags (41, 42), wherein each individual filter bag is supported by a metal cage (2, 3). The bag filter system is configured to determine an amount of dust (21) accumulated on surfaces of filter bags. Impedance-measuring equipment (43) is connected to the metal cages of at least two adjacent filter bags to determine an impedance value between the cages of the at least two adjacent bags. Since the determined impedance value is indicative of the amount of dust accumulated on the surfaces of the adjacent bags, it can be used for deciding when it is appropriate to initiate a cleaning process of these bags. In this way, it is ensured that bags are only cleaned when needed, and savings on compressed cleaning air as well as an extension of bag life can be achieved.

### TECHNICAL FIELD

The invention relates to a bag filter system configured to determine an amount of dust accumulated on surfaces of filter bags. The invention also relates to a method of determining an amount of dust accumulated on surfaces of filter bags in a bag filter system.

### BACKGROUND

Bag filter systems or bag filters, which are also known as bag houses or fabric filters, are used for removal of particulate matter, such as dust, from a flow of air or gas in various industrial applications with the purpose of controlling emission of pollution to the surroundings. Typically, bag filters have a high particulate collection efficiency, e.g. better than 99%.

A bag filter system typically comprises a plurality of long, cylindrical filter bags made of woven or felted fabric. The individual filter bags are arranged in a vertical position parallel to each other in a filter housing. Often, a bag filter system will have several hundred filter bags. Dependent on the bag filter type, the filter bags may have their opening arranged at either the top or the bottom of the filter housing. Dirty gas or air polluted with particulate matter normally enters the filter housing at its bottom and is drawn through the filter bags, so that a layer of dust accumulates on the surface of the filter bags. Thus, the dirty gas flows from inside to outside of filter bags having their opening facing downwards, and the dust layer will be deposited on the inside of the filter bags. Correspondingly, the dirty gas flows from outside to inside of filter bags having their opening facing upwards, and the dust layer will be deposited on the outside of the filter bags.

Usually, individual filter bags with their opening facing upwards are supported by a metal cage, which is fastened to a tube sheet or plate at the top of the filter housing. The metal cage of each filter bag prevents the bag from collapsing in the airflow.

When an airflow passes through a bag filter, a certain pressure drop, delta P, will occur, which depends on the filter media, the filter housing and the flow. As the dust layer on the filter bags accumulates, the pressure drop increases until air can no longer move through the bag filter, because it is clogged, and it has to be replaced or cleaned. Thus, a bag filter that is nearly clogged has a higher pressure drop than a new and clean filter.

Consequently, the filter bags of a bag filter have to be cleaned from time to time, unless they are replaced when they are clogged. Cleaning of the filter bags can take place online or offline, depending on filter type. Online cleaning means that the filter bags are cleaned during normal filter operation without interruption of the airflow during the filter. By offline cleaning, the filtration process is stopped while the filter bags are cleaned. When the filter bags have been cleaned, the normal filtering operation can be resumed. Different cleaning methods can be used, depending on the filter type. Among the mostly used cleaning methods, mechanical shaking, reverse air and pulse jet or reverse jet can be mentioned.

Bag filters using offline cleaning can be divided into sections or compartments, compartmentalized, to allow continuous operation of the filter. One at a time, each compartment is periodically closed off from the incoming dirty gas stream, cleaned, and then brought back online. While the individual compartment is out of place, the gas stream is diverted from the closed compartment to the remaining compartments. In this way, it is not necessary to shut down the production process during cleaning cycles.

The bag filters, or the compartments for compartmentalized bag filters, can be cleaned periodically, so that a filter or a compartment is cleaned when a certain time has elapsed since its previous cleaning cycle. However, since the amount of dust accumulated on the filter bags may vary considerably over time in dependence of the process generating the dust, this method will typically lead to over cleaning, which is undesired because each cleaning cycle affects the life time of the filter bags and requires compressed air, which leads to energy loss.

Instead, the pressure drop, also called the differential pressure, over the filter can be measured. As mentioned above, the pressure drop over the filter increases with the amount of dust accumulated on the bags of the filter, and therefore, the measured pressure drop can be used as an indication of when a cleaning cycle for the bag filter is needed.

However, the dust load on individual filter bags in the bag filter can vary considerably, and especially in a compartmentalized bag filter, the dust load on the filter bags can vary considerably from one compartment to another, while the measured pressure drop can only be used as an indication of an average amount of dust for the whole filter, and thus this method will still lead to over cleaning of some filter bags or some compartments.

U.S. Pat. No. 4,400,971 suggests that the amount of particulate matter deposited on a filter bag of a bag filter can be determined by measuring a capacitance between a first perforated electrode, on which the filter bag is mounted and supported, and one or more other electrodes that are arranged around the filter bag and the first electrode. However, this solution results in a complicated and expensive construction of the bag filter, because all bags for which the amount of particulate matter should be determined must be provided with the special electrodes around the filter bag. These electrodes affect the flow in the filter and may also impede the cleaning process.

### SUMMARY OF THE INVENTION

Therefore, it is an object of embodiments of the invention to provide a bag filter system in which the amount of dust accumulated on filter bags can be determined separately for individual filter bags, for groups or rows of filter bags or for individual compartments, without the need of arranging special electrodes around the filter bags of the bag filter system.

According to embodiments of the invention the object is achieved in a bag filter system for removing dust from a gas flow, the bag filter system comprising a plurality of filter bags, wherein each individual filter bag is supported by a metal cage; and wherein the bag filter system is further configured to determine an amount of dust accumulated on surfaces of filter bags. The object is achieved when the bag filter system further comprises impedance-measuring equipment connected to the metal cages of at least two adjacent filter bags to determine an impedance value between the metal cages of said at least two adjacent filter bags.

The determined impedance value represents the capacitance between the metal cages of the at least two adjacent filter bags, and since this capacitance is a function of the amount of dust accumulated on the surfaces of these filter bags, the impedance value can be used as a direct indication of the amount of accumulated dust on the corresponding filter bags. By measuring the impedance between two or more adjacent metal cages there is no need to provide any special electrodes around the filter bags. Thus, a simple way of determining the amount of dust accumulated on filter bags separately for individual filter bags, for groups or rows of filter bags or for individual compartments is achieved. Further, the system can be used to determine aging of filter bags and indicate the operator to replace the bags before damage, thereby avoiding failure and pollution, and if a filter bag has failed, the failed bag in a compartment comprising hundreds of bags can be determined. This can be done since the measured impedance also depends on the thickness of the bag material.

The bag filter system may comprise impedance-measuring equipment connected to the metal cages of a plurality of pairs of adjacent filter bags to determine an impedance value between the metal cages of each of said plurality of pairs of adjacent filter bags. In this way, the amount of dust accumulated on filter bags can be determined for different locations in the bag filter system.

In an embodiment, the bag filter system comprises impedance measuring-equipment connected to the metal cages of at least two adjacent rows of filter bags to determine an impedance value between the metal cages of said at least two adjacent rows of filter bags. Measuring the impedance between two rows filter bags gives a better indication of the amount of dust in an area of the bag filter system. In this case, the bag filter system may comprise impedance-measuring equipment connected to the metal cages of a plurality of adjacent rows of filter bags to determine an impedance value between the metal cages of each of said a plurality of adjacent rows of filter bags. In this way, the amount of dust accumulated on filter bags can be determined for different areas of the bag filter system.

The bag filter system may comprise a plurality of compartments, each compartment comprising a plurality of filter bags. In this case, the bag filter system may comprise impedance-measuring equipment connected to the metal cages of at least two adjacent filter bags in each compartment to determine an impedance value between the metal cages of said at least two adjacent filter bags in each compartment. In this way, the amount of dust accumulated on filter bags can be determined for individual compartments in a compartmentalized bag filter system.

In an embodiment, the impedance-measuring equipment is configured to determine said impedance value as a capacitance measured between the metal cages of said at least two adjacent filter bags. Depending on the available measuring equipment, it may be more convenient to measure the capacitance directly.

The bag filter system may further be configured to initiate a cleaning process of at least the filter bags supported by said at least two metal cages in dependence of said determined impedance value. Cleaning the filter bags only when it is needed because of the amount of accumulated dust reduces the wear on the filter bags and saves energy in the cleaning process.

As mentioned, the invention also relates to a method of determining an amount of dust accumulated on surfaces of filter bags in a bag filter system comprising a plurality of filter bags, wherein each individual filter bag is supported by a metal cage. The method comprises the steps of connecting impedance-measuring equipment to the metal cages of at least two adjacent filter bags; and determining by said impedance measuring equipment an impedance value between the metal cages of said at least two adjacent filter bags.

The determined impedance value represents the capacitance between the metal cages of the at least two adjacent filter bags, and since this capacitance is a function of the amount of dust accumulated on the surfaces of these filter bags, the impedance value can be used as a direct indication of the amount of accumulated dust on the corresponding filter bags. By measuring the impedance between two or more adjacent metal cages there is no need to provide any special electrodes around the filter bags. Thus, a simple way of determining the amount of dust accumulated on filter bags separately for individual filter bags, for groups or rows of filter bags or for individual compartments is achieved. Further, the method can be used to determine aging of filter bags and indicate the operator to replace the bags before damage, thereby avoiding failure and pollution, and if a filter bag has failed, the failed bag in a compartment comprising hundreds of bags can be determined. This can be done since the measured impedance also depends on the thickness of the bag material.

In an embodiment, the method comprises the step of determining said impedance value as a capacitance measured between the metal cages of said at least two adjacent filter bags. Depending on the available measuring equipment, it may be more convenient to measure the capacitance directly.

The method may further comprise the step of initiating a cleaning process of at least the filter bags supported by said at least two metal cages in dependence of said determined impedance value. Cleaning the filter bags only when it is needed because of the amount of accumulated dust reduces the wear on the filter bags and saves energy in the cleaning process.

### BRIEF DESCRIPTION OF THE DRAWINGS

Embodiments of the invention will now be described more fully below with reference to the drawings, in which

FIG. 1 shows an example of a metal cage for supporting filter bags in a bag filter,

FIG. 2 shows a filter bag mounted on the metal cage of FIG. 1,

FIG. 3 shows a cross-sectional side view of the filter bag of FIG. 2,

FIG. 4 shows a cross-sectional side view of an example of a bag filter with a plurality of filter bags placed vertically next to each other,

FIG. 5 shows a top view of the bag filter of FIG. 4,

FIGS. 6a, 6b and 6c show the bag filter of FIG. 3 with different amounts of dust accumulated on the filter,

FIG. 7 shows a top view of a compartmentalized bag filter,

FIG. 8 shows an impedance-measuring device connected to the metal cages of two adjacent filter bags,

FIG. 9 shows the bag filter of FIG. 5 with two impedance-measuring devices connected to the metal cages of two separate pairs of adjacent filter bags,

FIG. 10 shows an impedance-measuring device connected to the metal cages of two adjacent rows of filter bags,

FIG. 11 shows the bag filter of FIG. 5 with an impedance-measuring device connected to the metal cages of two adjacent rows of filter bags,

FIG. 12 shows the compartmentalized bag filter of FIG. 7 with impedance-measuring devices connected to the metal cages of two adjacent rows of filter bags in each compartment, and

FIG. 13 shows a flow chart illustrating a method of determining an amount of dust accumulated on surfaces of filter bags in a bag filter system comprising a plurality of filter bags.

### DETAILED DESCRIPTION

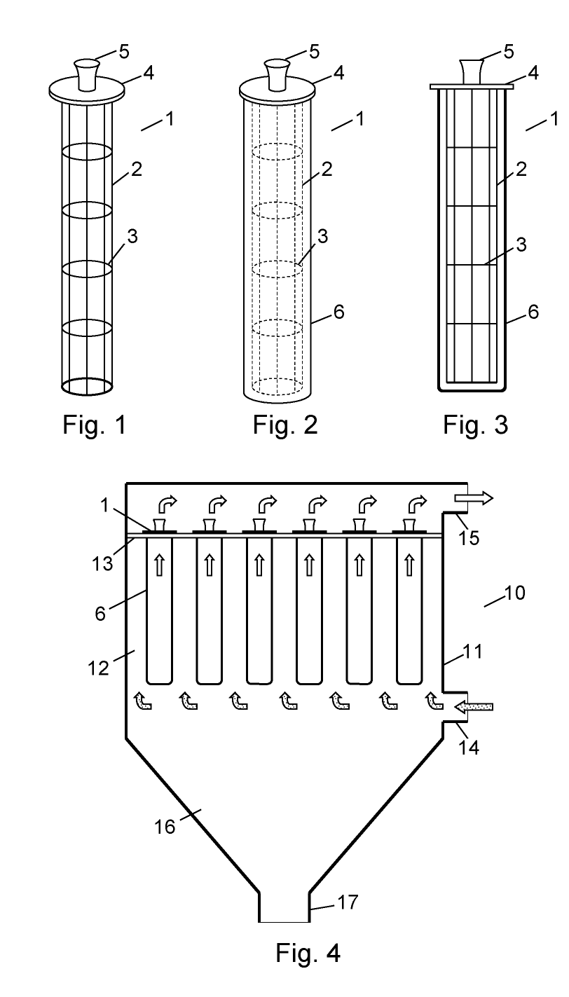

FIG. 1 shows an example of a metal cage 1 for supporting filter bags in a bag filter. The metal cage 1 is made of a number of rods or stringers 2 attached to a number of rings 3, so that the metal cage 1 has a cylindrical shape. At the top of the metal cage 1, the stringers 2 are connected to a circular cage top 4, in the middle of which a venturi nozzle 5 is arranged. The function of the venturi nozzle 5 will be explained later.

In FIG. 2, a filter bag 6 made of woven or felted fabric is mounted on the metal cage 1. Dashed lines indicate the position of the stringers 2 and the rings 3 inside the filter bag 6. The metal cage 1 prevents the filter bag 6 from collapsing during use. A cross-sectional side view of the filter bag 6 mounted on the metal cage 1 is shown in FIG. 3.

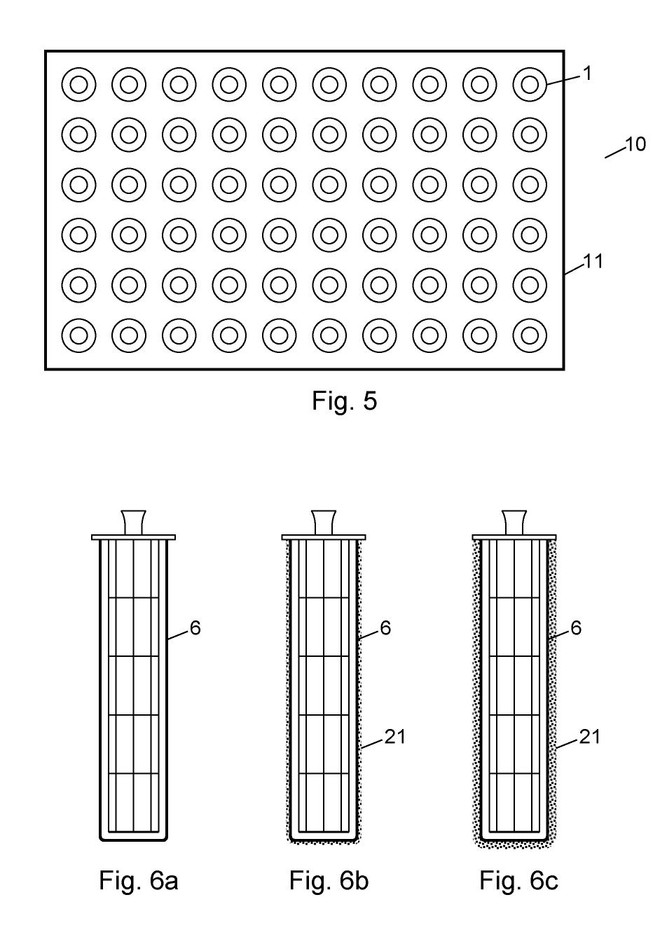

FIG. 4 shows a cross-sectional side view of an example of a bag filter 10 arranged in a filter housing 11. A bag filter is also known as a bag house or a fabric filter. In a main housing part 12 of the bag filter 10, a plurality of filter bags 6 are placed vertically next to each other. At the top of the main housing part 12, the filter bags 6 and their metal cages 1 are fastened to a tube sheet 13, which may also be called a cell plate. Dirty gas, i.e. air containing dust or other particulate matter, enters the filter housing 11 through an air inlet 14 at the bottom of the main housing part 12 and is directed to the space around the filter bags 6, where it is drawn through the filter material of the bags from the outside to the inside of the filter bags 6, so that a layer of dust is accumulated on the outside of the bags. The cleaned air leaves the filter bags 6 via the venturi nozzles at the top of their metal cages and exits the filter housing through an air outlet 15. A top view of the bag filter 10 is shown in FIG. 5. In this example, the bag filter 10 comprises six rows of filter bags with 10 bags in each row. However, large bag filters may have hundreds of filter bags.

When the bag filter 10 is active, dust from the dirty gas will, as mentioned, be deposited on the outside of the filter bags 6, and a dust layer or dust cake is accumulated. This is illustrated in FIGS. 6a to 6c. FIG. 6a, which corresponds to the cross-sectional side view of the filter bag from FIG. 3, shows a clean filter bag 6, representing either a new bag or a bag that has just been cleaned, and thus no dust layer is present on the filter bag. In FIG. 6b, the filter bag 6 has been in use for some time, and a dust layer 21 has been deposited on the outside of the bag. In FIG. 6c the amount of dust accumulated on the surface of the filter bag 6, i.e. the thickness of the dust layer 21, has increased after some further time in use. When the airflow passes through the bag filter 10, a certain pressure drop, delta P, occurs. As the dust layer on the filter bags 6 accumulates, the pressure drop increases until air can no longer move through the bag filter, because it is clogged, and therefore the filter bags have to be cleaned.

Typically, the type of bag filter shown in FIGS. 4 and 5 is cleaned by the pulse jet method, also known as the reverse jet method, but other cleaning methods, such as mechanical shaking and reverse air, can also be used. In the pulse jet method, the filter bags are cleaned by a short burst of compressed air through a not shown common manifold over e.g. a row of bags. The burst of compressed air is accelerated by the venturi nozzle 5 mounted on the circular cage top 4 at the top of each filter bag 6. The duration of the burst of compressed air is short, e.g. in the range of 0.1 second, and it acts as an air bubble that is rapidly moving through the entire length of the filter bag 6, and it causes the bag surfaces to flex so that the dust layer or dust cake breaks and the dust falls into a hopper section 16 arranged below the main housing part 12 of the bag filter 10, as it can be seen in FIG. 4. The hopper section 16 is a funnel-shaped container used for storing the dust until it is removed through an opening 17 at the bottom of the hopper 16.

Although some bag filter types allow the described cleaning process to be performed online, which means that the filter bags are cleaned during normal filter operation without interruption of the airflow during the filter, it is most common to perform the cleaning process offline, where the filtration process is stopped while the filter bags are cleaned. When the filter bags have been cleaned, the normal filtering operation can be resumed.

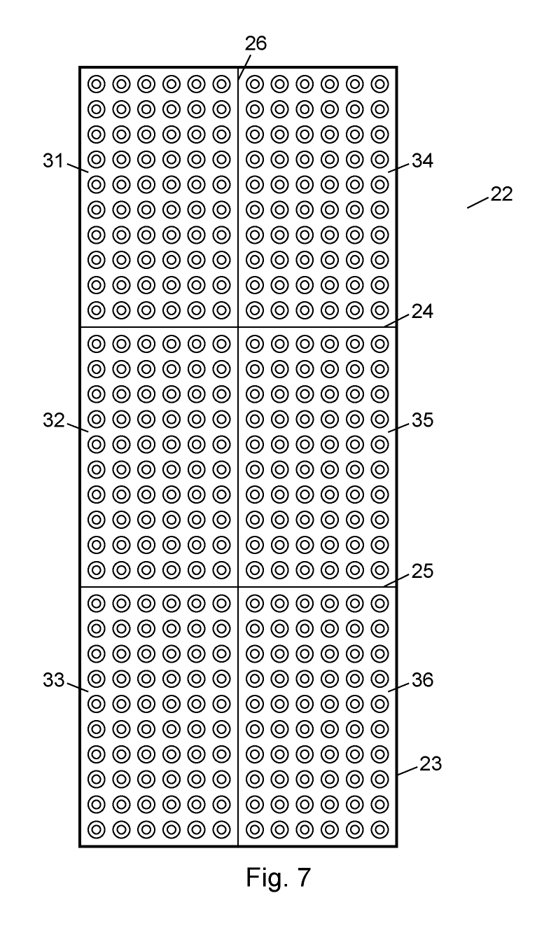

When continuous filtering operation is required, which is normally the case, bag filters using offline cleaning can be compartmentalized, i.e. they are divided into a number of sections or compartments. One at a time, the compartments are periodically closed off from the incoming dirty gas stream, cleaned, and then brought back online. While individual compartments are being cleaned, the gas stream is diverted from the closed compartment to the remaining compartments. In this way, it is not necessary to shut down the production process during cleaning cycles. An example of a compartmentalized bag filter 22 is shown in a top view in FIG. 7. By means of internal walls 24, 25 and 26 the filter housing 23 of the bag filter 22 is divided into six compartments 31, 32, 33, 34, 35 and 36. In the shown example, each compartment comprises six rows of filter bags with 10 bags in each row. When the filter bags of e.g. compartment 31 have to be cleaned, this compartment is closed off and the air flow of the dirty gas is divided between the five remaining compartments 32, 33, 34, 35 and 36 during the cleaning of compartment 31.

Typically, cleaning of the filter bags is performed with a certain frequency, so that the filter bags of a filter or a compartment is cleaned when a certain time has elapsed since its previous cleaning cycle, or the cleaning cycles are scheduled in dependence of a measurement of the pressure drop, i.e. the differential pressure, over the filter, since the pressure drop over the filter increases with the amount of dust accumulated on the bags of the filter.

However, the amount of dust accumulated on the filter bags may vary considerably over time in dependence of the process generating the dust. Also the dust load on individual filter bags in the bag filter can vary considerably, and especially in a compartmentalized bag filter, the dust load on the filter bags can vary considerably from one compartment to another. For compartmentalized bag filters, the measured pressure drop can only be used as an indication of an average amount of dust for the whole filter.

Therefore, these methods will typically lead to over cleaning of at least some filter bags or some compartments, which is undesired because each cleaning cycle affects the life time of the filter bags and requires compressed air, which leads to energy loss.

A different method of determining the amount of dust accumulated on the filter bags, i.e. the thickness of the dust layer, and thus also for determining when to perform a cleaning cycle of individual filter bags, individual compartments or the whole bag filter, is described below.

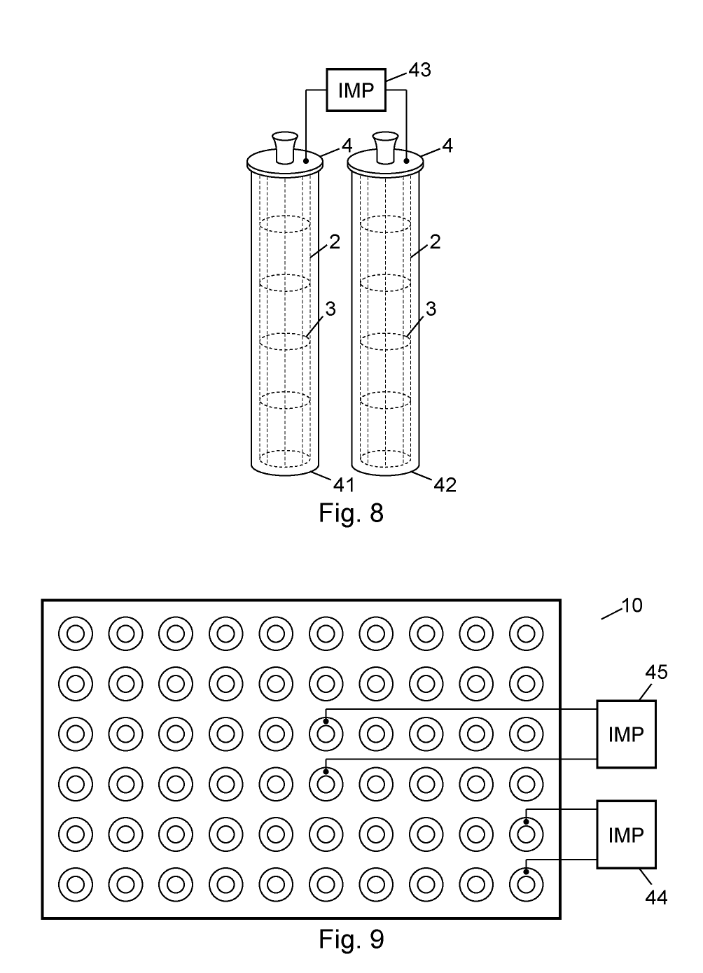

FIG. 8 shows two filter bags 41 and 42, which can be any two adjacent filter bags in e.g. the bag filter 10 in FIGS. 4 and 5 or the bag filter 22 in FIG. 7. The metal cages of the two filter bags 41 and 42 with their respective stringers 2 and rings 3 can be considered as metallic plates of a capacitor, where the dielectric medium of the capacitor is bag material, dust and air.

As described above, the thickness of the dust layer increases during the filtering process which results in a change in the dielectric medium. Therefore, the capacitance between the two cages will be dependent on the thickness of the dust layer on the two filter bags 41 and 42, i.e. the amount of dust accumulated on the surfaces of the two bags. If the bag material is considered constant and thus disregarded, the general formula for the capacitance between the two cages is

$$C = \frac{{ɛ}_{0} A}{{d}_{1} / {k}_{1} + {d}_{2} / {k}_{2}} ,$$

where ε₀ is the permittivity of free space, A is the cross-sectional area of each electrode, i.e. the metal cage, d₁ and d₂ are the relative thicknesses of the air layer and the dust layer, and k₁ and k₂ are the dielectric constants of air and dust, respectively.

Since the capacitance between the two cages depends on the amount of dust accumulated on the surfaces of the two bags, a measurement of that capacitance can be used as an indication of the amount of accumulated dust. The capacitance value will increase with increased amount of dust. In this way, the amount of dust can be determined during normal operating conditions of the bag filter.

Instead of measuring the capacitance directly, the impedance of the capacitor can be measured. Since the impedance of the capacitor at a given measuring frequency is inversely proportional to the capacity, a measurement of the impedance can just as well be used as an indication of the amount of accumulated dust, and the impedance can typically be measured with a simpler type of measuring device compared to the capacitance.

Thus, in FIG. 8, an impedance-measuring device 43 is connected to the metal cages of the two filter bags 41 and 42. In this embodiment, the impedance-measuring device 43 is connected to the circular cage top 4 of each metal cage. However, if the cage top is not metallic and/or electrically connected to the stringers 2 and rings 3 of the metal cage, the impedance-measuring device 43 can instead be connected directly to e.g. one of the stringers 2 or to the venturi nozzle 5. The two metal cages and their components should of course be electrically insulated from each other and from other metallic components of the bag filter, such as a top plate or the like.

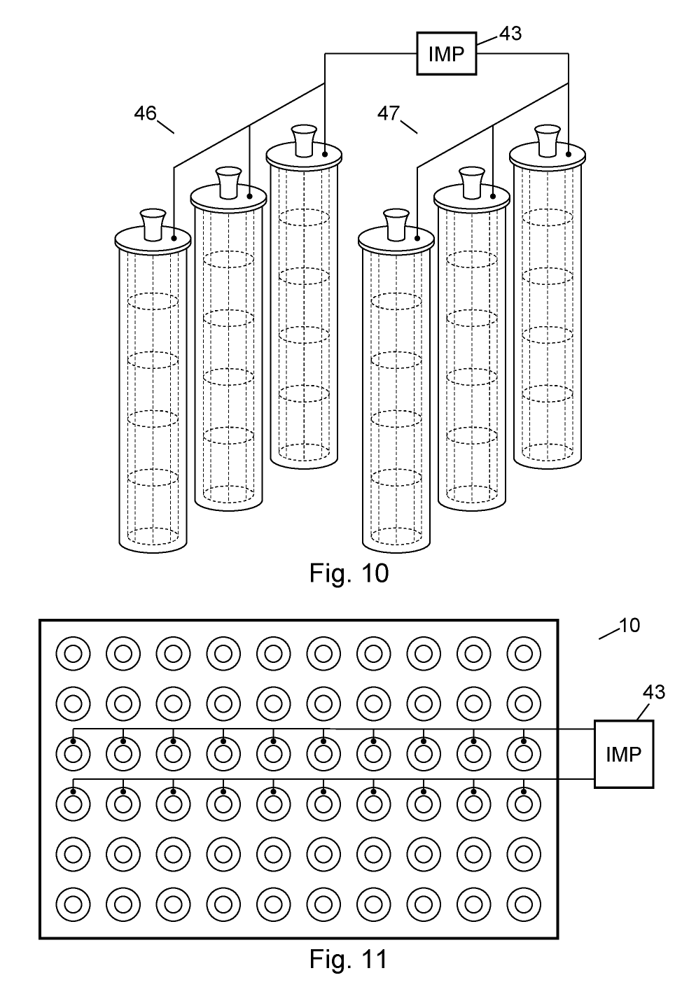

The two adjacent filter bags 41 and 42, to which the impedance-measuring device 43 is connected, can be selected as any two adjacent filter bags in the bag filter, and it is also possible to measure the impedance between several pairs of filter bags at different locations in the filter, either by multiplexing the impedance-measuring device between the pairs, or by using a separate impedance-measuring device for each pair. As an example, FIG. 9 shows the bag filter 10 of FIG. 5 with an impedance-measuring device 44 connected to a pair of filter bags placed in a corner of the filter and another impedance-measuring device 45 connected to a pair of filter bags placed in the middle of the filter. In this way, the difference in dust load between the middle of the filter and near the edge of the filter can be determined.

It is also possible to connect each one of all the filter bags in the bag filter electrically to a switching arrangement, so that an impedance-measuring device at any time can be connected to any selected pair of adjacent filter bags in the filter. Thus by sequentially measuring on all adjacent pairs of filter bags, one pair after the other, an indication can be obtained of how the dust load is distributed over the entire filter. This indication of the dust load distribution can then be used for scheduling the cleaning cycles for the bags of the filter.

In addition to determining the thickness of the dust layer, the system can also be used to determine wear and/or damage of filter bags due to aging of the bags, and thus in case of a failure to detect which bag in a filter or compartment comprising a high number of bags that has failed. The system can thus give an indication to an operator about replacing bags before damage, thereby avoiding failure and pollution. This can be done by also measuring the capacitance or the impedance of filter bags that have just been cleaned, which indirectly measures the thickness of the bag material, and comparing with previous measurements of cleaned bags or a predetermined value. Thus, in case of an old or worn filter bag, the change in thickness of the bag material or a tear in the bag can be determined.

In another embodiment, the metal cages of a number of filter bags in e.g. a row of filter bags can be connected together, and the capacitance or the impedance between these metal cages and the metal cages of filter bags in an adjacent row can be measured. This is illustrated in FIG. 10, where an impedance-measuring device 43 is connected to measure the impedance between the metal cages of a first row of filter bags 46 and the metal cages of an adjacent row of filter bags 47.

The two adjacent rows 46 and 47, to which the impedance-measuring device 43 is connected, can be selected as any two adjacent rows of filter bags in the bag filter. Again, it is also possible to measure the impedance between several adjacent rows of filter bags at different locations in the filter, either by multiplexing the impedance-measuring device between the rows, or by using a separate impedance-measuring device for each pair of adjacent rows. As an example, FIG. 11 shows the bag filter 10 of FIG. 5 with the impedance-measuring device 43 connected to a pair of adjacent rows of filter bags placed in the middle of the filter. However, two adjacent rows near the edge of the filter could just as well have been selected, or one impedance-measuring device could be connected to two adjacent rows in the middle of the filter and another impedance-measuring device to two adjacent rows near the edge of the filter. In this way, the difference in dust load between the middle of the filter and near the edge of the filter can be determined, and the cleaning cycles of the filter bags can be scheduled based on this difference. The two adjacent rows need not be full rows of the filter. Thus in FIG. 11, the impedance-measuring device 43 could be connected to e.g. only the five rightmost pairs of filter bags in the two adjacent rows.

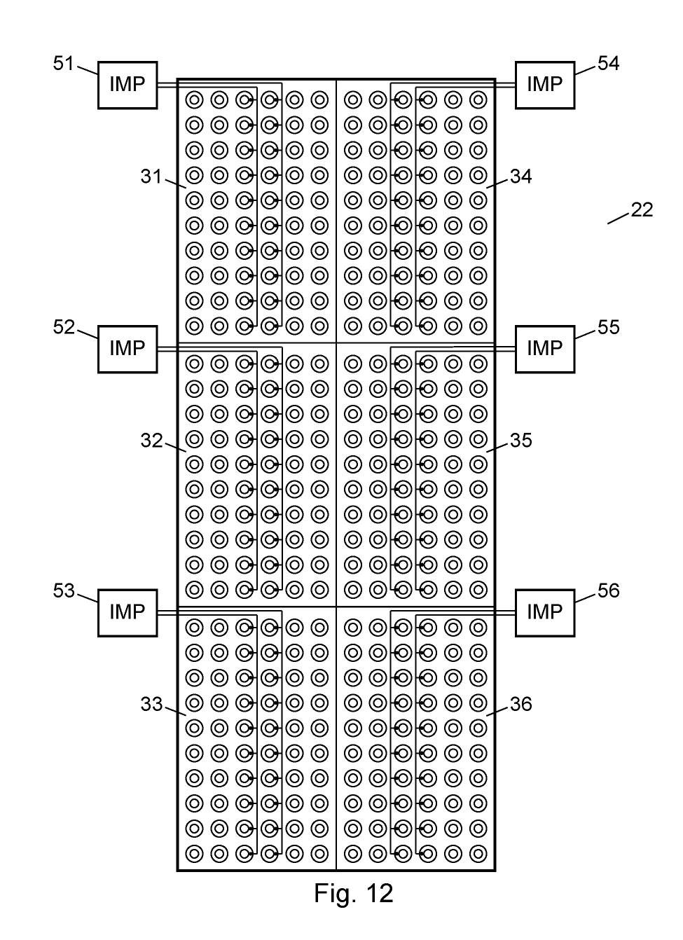

FIG. 12 illustrates the use of the method in a compartmentalized bag filter with the filter 22 of FIG. 7 as an example. In each of the six compartments 31, 32, 33, 34, 35 and 36 a pair of adjacent rows of filter bags placed in the middle of the compartment is connected to an impedance-measuring device 51, 52, 53, 54, 55 and 56, respectively. In this way, the difference in dust load between the compartments can easily be determined, and the cleaning of the compartments can be scheduled accordingly. Again, other adjacent rows of filter bags could be used instead of those placed in the middle of the compartment, or the impedance of several pairs of adjacent rows of filter bags in each compartment could be measured. It can be noted that the dust load need not be determined for all compartments. The cleaning cycles for the compartmentalized bag filter can then be based on measurements in some selected compartments.

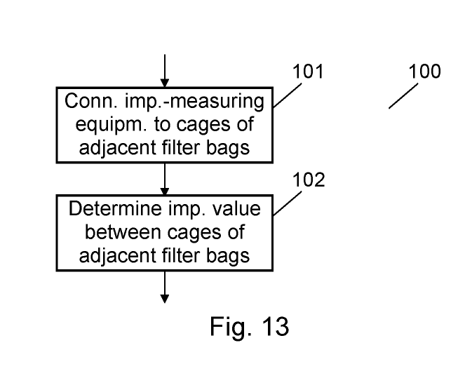

FIG. 13 shows a flow chart 100 illustrating a method of method of determining an amount of dust accumulated on surfaces of filter bags in a bag filter system comprising a plurality of filter bags, where each individual filter bag is supported by a metal cage. In step 101, impedance-measuring equipment is connected to the metal cages of two or more adjacent filter bags as it has been described for the embodiments mentioned above. In step 102, the impedance measuring equipment determines an impedance value between the metal cages of the adjacent filter bags. The determined impedance value can then be used as an indication of the amount of dust accumulated on the surfaces of the adjacent filter bags, and thus form the basis for the decision of when the bags should be cleaned.

In other words, a bag filter system 10; 22 for removing dust from a gas flow is disclosed, the bag filter system comprising a plurality of filter bags 6, wherein each individual filter bag 6 is supported by a metal cage 1; and wherein the bag filter system is further configured to determine an amount of dust 21 accumulated on surfaces of filter bags 6. The bag filter system further comprises impedance-measuring equipment 43; 44, 45; 51, 52, 53, 54, 55, 56 connected to the metal cages 1 of at least two adjacent filter bags 41, 42; 46, 47 to determine an impedance value between the metal cages of said at least two adjacent filter bags 41, 42; 46, 47.

The determined impedance value represents the capacitance between the metal cages of the at least two adjacent filter bags, and since this capacitance is a function of the amount of dust accumulated on the surfaces of these filter bags, the impedance value can be used as a direct indication of the amount of accumulated dust on the corresponding filter bags. By measuring the impedance between two or more adjacent metal cages there is no need to provide any special electrodes around the filter bags. Thus, a simple way of determining the amount of dust accumulated on filter bags separately for individual filter bags, for groups or rows of filter bags or for individual compartments is achieved. Further, the system can be used to determine aging of filter bags and indicate the operator to replace the bags before damage, thereby avoiding failure and pollution, and if a filter bag has failed, the failed bag in a compartment comprising hundreds of bags can be determined. This can be done since the measured impedance also depends on the thickness of the bag material.

The bag filter system may comprise impedance-measuring equipment 44, 45 connected to the metal cages of a plurality of pairs of adjacent filter bags to determine an impedance value between the metal cages of each of said plurality of pairs of adjacent filter bags. In this way, the amount of dust accumulated on filter bags can be determined for different locations in the bag filter system.

In an embodiment, the bag filter system comprises impedance measuring-equipment 43 connected to the metal cages of at least two adjacent rows 46, 47 of filter bags to determine an impedance value between the metal cages of said at least two adjacent rows of filter bags. Measuring the impedance between two rows filter bags gives a better indication of the amount of dust in an area of the bag filter system. In this case, the bag filter system may comprise impedance-measuring equipment connected to the metal cages of a plurality of adjacent rows of filter bags to determine an impedance value between the metal cages of each of said a plurality of adjacent rows of filter bags. In this way, the amount of dust accumulated on filter bags can be determined for different areas of the bag filter system.

The bag filter system may comprise a plurality of compartments 31, 32, 33, 34, 35, 36, each compartment comprising a plurality of filter bags. In this case, the bag filter system may comprise impedance-measuring equipment 51, 52, 53, 54, 55, 56 connected to the metal cages of at least two adjacent filter bags in each compartment 31, 32, 33, 34, 35, 36 to determine an impedance value between the metal cages of said at least two adjacent filter bags in each compartment. In this way, the amount of dust accumulated on filter bags can be determined for individual compartments in a compartmentalized bag filter system.

In an embodiment, the impedance-measuring equipment is configured to determine said impedance value as a capacitance measured between the metal cages of said at least two adjacent filter bags. Depending on the available measuring equipment, it may be more convenient to measure the capacitance directly.

The bag filter system may further be configured to initiate a cleaning process of at least the filter bags supported by said at least two metal cages in dependence of said determined impedance value. Cleaning the filter bags only when it is needed because of the amount of accumulated dust reduces the wear on the filter bags and saves energy in the cleaning process.

The invention also relates to a method of determining an amount of dust 21 accumulated on surfaces of filter bags 6 in a bag filter system 10; 22 comprising a plurality of filter bags, wherein each individual filter bag 6 is supported by a metal cage 1. The method comprises the steps of connecting 101 impedance-measuring equipment 43; 44, 45; 51, 52, 53, 54, 55, 56 to the metal cages of at least two adjacent filter bags 41, 42; 46, 47; and determining 102 by said impedance measuring equipment an impedance value between the metal cages of said at least two adjacent filter bags 41, 42; 46, 47.

The determined impedance value represents the capacitance between the metal cages of the at least two adjacent filter bags, and since this capacitance is a function of the amount of dust accumulated on the surfaces of these filter bags, the impedance value can be used as a direct indication of the amount of accumulated dust on the corresponding filter bags. By measuring the impedance between two or more adjacent metal cages there is no need to provide any special electrodes around the filter bags. Thus, a simple way of determining the amount of dust accumulated on filter bags separately for individual filter bags, for groups or rows of filter bags or for individual compartments is achieved. Further, the method can be used to determine aging of filter bags and indicate the operator to replace the bags before damage, thereby avoiding failure and pollution, and if a filter bag has failed, the failed bag in a compartment comprising hundreds of bags can be determined. This can be done since the measured impedance also depends on the thickness of the bag material.

In an embodiment, the method comprises the step of determining said impedance value as a capacitance measured between the metal cages of said at least two adjacent filter bags. Depending on the available measuring equipment, it may be more convenient to measure the capacitance directly.

The method may further comprise the step of initiating a cleaning process of at least the filter bags supported by said at least two metal cages in dependence of said determined impedance value. Cleaning the filter bags only when it is needed because of the amount of accumulated dust reduces the wear on the filter bags and saves energy in the cleaning process.

Although various embodiments of the present invention have been described and shown, the invention is not restricted thereto, but may also be embodied in other ways within the scope of the subject-matter defined in the following claims.

1. A bag filter system (10; 22) for removing dust from a gas flow, the bag filter system comprising a plurality of filter bags (6), wherein each individual filter bag (6) is supported by a metal cage (1); and wherein the bag filter system is further configured to determine an amount of dust (21) accumulated on surfaces of filter bags (6), characterised in that the bag filter system (10; 22) further comprises impedance-measuring equipment (43; 44, 45; 51, 52, 53, 54, 55, 56) connected to the metal cages (1) of at least two adjacent filter bags (41, 42; 46, 47) to determine an impedance value between the metal cages of said at least two adjacent filter bags (41, 42; 46, 47).

2. A bag filter system according to claim 1, wherein the bag filter system comprises impedance-measuring equipment (44, 45) connected to the metal cages of a plurality of pairs of adjacent filter bags to determine an impedance value between the metal cages of each of said plurality of pairs of adjacent filter bags.

3. A bag filter system according to claim 1 or 2, wherein the bag filter system comprises impedance measuring-equipment (43) connected to the metal cages of at least two adjacent rows (46, 47) of filter bags to determine an impedance value between the metal cages of said at least two adjacent rows of filter bags.

4. A bag filter system according to claim 3, wherein the bag filter system comprises impedance-measuring equipment connected to the metal cages of a plurality of adjacent rows of filter bags to determine an impedance value between the metal cages of each of said a plurality of adjacent rows of filter bags.

5. A bag filter system according to any one of claims 1 to 4, wherein the bag filter system (22) comprises a plurality of compartments (31, 32, 33, 34, 35, 36), each compartment comprising a plurality of filter bags.

6. A bag filter system according to claim 5, wherein the bag filter system comprises impedance-measuring equipment (51, 52, 53, 54, 55, 56) connected to the metal cages of at least two adjacent filter bags in each compartment (31, 32, 33, 34, 35, 36) to determine an impedance value between the metal cages of said at least two adjacent filter bags in each compartment.

7. A bag filter system according to any one of claims 1 to 6, wherein the impedance-measuring equipment is configured to determine said impedance value as a capacitance measured between the metal cages of said at least two adjacent filter bags.

8. A bag filter system according to any one of claims 1 to 7, wherein the bag filter system is further configured to initiate a cleaning process of at least the filter bags supported by said at least two metal cages in dependence of said determined impedance value.

9. A method of determining an amount of dust (21) accumulated on surfaces of filter bags (6) in a bag filter system (10; 22) comprising a plurality of filter bags, wherein each individual filter bag (6) is supported by a metal cage (1), characterised in that the method comprises the steps of:
connecting (101) impedance-measuring equipment (43; 44, 45; 51, 52, 53, 54, 55, 56) to the metal cages of at least two adjacent filter bags (41, 42; 46, 47); and
determining (102) by said impedance measuring equipment an impedance value between the metal cages of said at least two adjacent filter bags (41, 42; 46, 47).

10. A method according to claim 9, wherein the method comprises the step of determining said impedance value as a capacitance measured between the metal cages of said at least two adjacent filter bags.

11. A method according to claim 9 or 10, wherein the method further comprises the step of initiating a cleaning process of at least the filter bags supported by said at least two metal cages in dependence of said determined impedance value.
